(19) United States
(12) Patent Application Publication
(10) Pub. No.: US 2015/0142882 A1
(43) Pub. Date: May 21, 2015

(54) CONTENT PROCESSING METHOD AND NETWORK SIDE DEVICE

(71) Applicant: Huawei Technologies Co., Ltd., Shenzhen (CN)

(72) Inventors: Wenfu WU, Shenzhen (CN); Yan LI, Shenzhen (CN); Yan WANG, Shenzhen (CN)

(21) Appl. No.: 14/577,650

(22) Filed: Dec. 19, 2014

Related U.S. Application Data
(63) Continuation of application No. PCT/CN2012/077190, filed on Jun. 20, 2012.

(51) Int. Cl. H04L 29/08; H04L 29/06

(52) U.S. Cl. CPC H04L 67/2842; H04L 67/10; H04L 67/42
USPC 709/203

(57) ABSTRACT

Embodiments of the present invention provide a content processing method and a network side device. The content processing method includes: determining that the application content needs to be cached in a content caching device in a network; and distributing the application content to the content caching device in the network. The content processing method and the network side device of the embodiments of the present invention may avoid HTTP proxy processing of a content delivery network, thereby reducing the complexity of the network processing.

### CROSS-REFERENCE TO RELATED APPLICATIONS

This application is a continuation of International Patent Application No. PCT/CN2012/077190, filed on Jun. 20, 2012, which is hereby incorporated by reference in its entirety.

### FIELD OF THE INVENTION

The present invention relates to the field of communications, and particularly, to a content processing method and a network side device, wherein the network side device includes an application server, a content caching device and a content control network element.

### BACKGROUND OF THE INVENTION

At present, a content delivery network (Content Delivery Network, referred to as “CDN” for short) is being researched in telecommunication technologies. Its purpose is to distribute application contents of a website to network “edges” closest to user equipments by adding a layer of new network architecture in an existing Internet (Internet), so that the user equipments acquire the required contents nearby instead of acquiring the contents from an application server, and thus the network congestion condition of the Internet network may be solved to improve the response speed of the user equipments accessing the website.

In this case, the specific implementation may be: after intercepting a hyper text transfer protocol (Hyper Text Transfer Protocol, referred to as “HTTP” for short) request of a user equipment, the CDN network executes a deep packet inspection (Deep Packet Inspection, referred to as “DPI” for short) function, to analyze the HTTP request sent by the user equipment (User Equipment, referred to as “UE” for short) so as to acquire the application content information requested by the user equipment. The CDN network counts the page views of the application content requested by the user equipment, and if the page views of the requested application content exceed a certain number, the CDN network determines to cache the application content in the CDN network. Thus, the CDN network is required to perform HTTP proxy (Proxy) processing, namely, the CDN network changes a source internet protocol (Internet Protocol, referred to as “IP” for short) address in the HTTP request into an IP address of its own network, and sends the changed HTTP request to the application server. After receiving an HTTP response message sent by the application server according to the HTTP request, the CDN network performs HTTP proxy processing, and forwards the HTTP response message to the UE; and caches the application content distributed by the application server and forwards the application content to the UE. After receiving the HTTP request sent by the UE subsequently, the CDN network does not forward the HTTP request to the application server, but directly replies the HTTP response message to the UE and directly distributes the cached application content to the UE.

However, in order to realize caching of the application content, the CDN network is required to intercept the HTTP request of the user equipment to perform the HTTP proxy processing, which increases the complexity of network processing.

Therefore, an appropriate technical solution is required to reduce the complexity of network processing.

### SUMMARY OF THE INVENTION

Embodiments of the present invention provide a content processing method, an application server, a content caching device and a content control network element, in which application contents are cached by the application server, so that the complexity of network processing may be reduced.

In one aspect, a content processing method is provided, including: determining that an application content needs to be cached in a content caching device in a network; and distributing the application content to the content caching device in the network.

In another aspect, a content processing method is provided, including: receiving an application content distributed by an application server, wherein the application content is distributed by the application server to a content caching device in the network after the application server determining to cache the application content in the content caching device in the network.

In yet another aspect, a content processing method is provided, including: receiving a content caching request, for requesting a network to cache application content, sent by an application server; determining a content caching device in the network; and sending a content caching response to the application server, so that the application server distributes the application content to the content caching device in the network.

In still another aspect, an application server is provided, including: a first determining module, configured to determine that an application content needs to be cached in a content caching device in a network; and a distributing module, configured to distribute the application content to the content caching device in the network.

In a further aspect, a content caching device is provided, including: a receiving module, configured to receive an application content distributed by an application server, wherein the application content is distributed by the application server to the content caching device in the network after the application server determining to cache the application content in the content caching device in the network.

In a still further aspect, a content control network element is provided, including: a first receiving module, configured to receive a content caching request, for requesting a network to cache an application content, sent by an application server; a determining module, configured to determine a content caching device in the network; and a first sending module, configured to send a content caching response to the application server, so that the application server distributes the application content to the content caching device in the network.

Based on the above-mentioned technical solutions, according to the content processing method, the application server, the content caching device and the content control network element in the embodiments of the present invention, the application server determines that the application content needs to be cached in the content caching device in the network, and distributes the application content to the content caching device in the network. Thus, HTTP proxy processing in a content delivery network may be avoided, thereby reducing the complexity of network processing.

### BRIEF DESCRIPTION OF THE DRAWINGS

To illustrate technical solutions in the embodiments of the present invention more clearly, accompanying drawings needed for describing the embodiments are introduced briefly in the following. Obviously, the accompanying drawings in the following description are some embodiments of the present invention, and persons of ordinary skill in the art may further obtain other accompanying drawings according to these accompanying drawings without making creative efforts.

FIG. 1 is a schematic flow chart of a content processing method according to an embodiment of the present invention;

FIG. 2 is a schematic flow chart of a content processing method according to another embodiment of the present invention;

FIG. 3 is a schematic flow chart of a content processing method according to another embodiment of the present invention;

FIG. 4 is a schematic flow chart of a content processing method according to another embodiment of the present invention;

FIG. 5 is a schematic flow chart of a content processing method according to another embodiment of the present invention;

FIG. 6 is a schematic flow chart of a content processing method according to another embodiment of the present invention;

FIG. 7 is a schematic flow chart of a content processing method according to another embodiment of the present invention;

FIG. 8 is a schematic block diagram of an application server according to an embodiment of the present invention;

FIG. 9 is a schematic block diagram of an application server according to another embodiment of the present invention;

FIG. 10 is a schematic block diagram of a content caching device according to an embodiment of the present invention;

FIG. 11 is a schematic block diagram of a content caching device according to another embodiment of the present invention;

FIG. 12 is a schematic block diagram of a content control network element according to an embodiment of the present invention;

FIG. 13 is a schematic block diagram of a content control network element according to another embodiment of the present invention.

### DETAILED DESCRIPTION OF THE EMBODIMENTS

A clear and complete description of technical solutions in embodiments of the present invention will be given below, in combination with the accompanying drawings in the embodiments of the present invention. Apparently, the embodiments described below are merely a part, but not all, of the embodiments of the present invention. All of other embodiments, obtained by those of ordinary skill in the art based on the embodiments of the present invention without making creative efforts, fall into the protection scope of the present invention.

It should be understood that, the technical solutions of the embodiments of the present invention may be applied to various communication systems, for example: a global system of mobile communication (Global System of Mobile communication, referred to as “GSM” for short) system, a code division multiple access (Code Division Multiple Access, referred to as “CDMA” for short) system, a wideband code division multiple access (Wideband Code Division Multiple Access, referred to as “WCDMA” for short) system, a general packet radio service (General Packet Radio Service, referred to as “GPRS” for short), a long term evolution (Long Term Evolution, referred to as “LTE” for short) system, an LTE frequency division duplex (Frequency Division Duplex, referred to as “FDD” for short) system, an LTE time division duplex (Time Division Duplex, referred to as “TDD” for short), a universal mobile telecommunication system (Universal Mobile Telecommunication System, referred to as “UMTS” for short) or the like.

A user equipment (User Equipment, referred to as “UE”, for short), also called a terminal, a mobile terminal (Mobile Terminal), a mobile user equipment and the like, may communicate with one or multiple core networks through a radio access network (e.g., Radio Access Network, referred to as “RAN” for short), a user may be a mobile terminal, for example, a mobile telephone (or called a “cellular” telephone) and a computer having a mobile terminal, for example, portable, pocket, hand-held, computer-built-in, vehicle-mounted mobile devices, and they exchange languages and/or data with the radio access network.

In the embodiments of the present invention, the application server may be a video server, may be a mail server, or may also be a file transfer protocol (File Transfer Protocol, referred to as “FTP” for short) server, wherein the FTP server is a server specially providing various files (File) for a user, a large number of files are generally stored in the FTP server, for example, software, moving picture experts group audio layer III (Moving Picture Experts Group Audio Layer III, referred to as “MP3” for short), film, program, etc.

In the embodiments of the present invention, the application content may be video, software, MP3, film, program, or an email content, etc.

In the embodiments of the present invention, the content caching device may be a video caching device, a file caching device or an email caching device or the like, may be an access network element (e.g., an eNodeB, a radio network controller (Radio Network Controller, referred to as “RNC” for short)), may also be a gateway device (e.g., a gateway general packet radio service support node (Gateway General Packet Radio Service Support Node, referred to as “GGSN” for short), a packet data network gateway (Packet Data Network Gateway referred to as “PDN GW” for short)) in a core network, or may also be a network element in a CDN network (e.g., a video storage gateway). For convenient description, the network element in the CDN network is called a CND network element in the following description.

In the embodiments of the present invention, an interface between network elements may be a message interface, or may also be an application programming interface (Application Programming Interface, referred to as “API” for short).

In the embodiments of the present invention, the content control network element may be a policy and charging rules function (Policy and Charging Rules Function, referred to as “PCRF” for short), an open platform, an SDP (Service delivery platform, service delivery platform), etc.

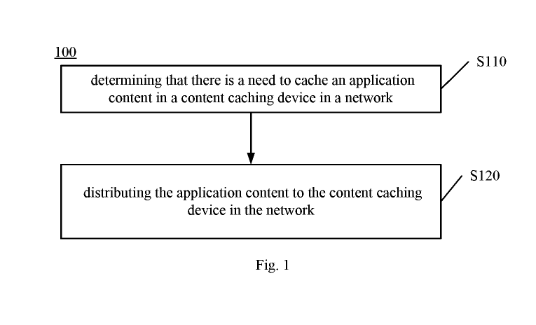

FIG. 1 is a schematic flow chart of a content processing method 100 according to an embodiment of the present invention, wherein the method 100 may be implemented by an application server. As shown in FIG. 1, the method 100 includes:

S110, determining that an application content needs to be cached in a content caching device in a network.

For example, the application server may count the page views of the application content within a particular area, and if the page views of the application content exceed a certain numerical value, the application server may determine that the application content needs to be cached in a content caching device in a network. As another example, the application server may determine whether the application content needs to be cached in the content caching device in the network according to whether a feature (e.g., a preset area to which the application content needs to be pushed) of the application content meets a preset condition, and if the feature of the application content meets the preset condition, the application server determines that the application content needs to be cached in the content caching device in the network, for example, the application server, after obtaining that the area to which the application content is needed to be pushed is located in some particular areas (e.g., some particular cells), may determine that the application content needs to be cached in the content caching device in the network.

S120, distributing the application content to the content caching device in the network.

For example, the application server obtains the area to which the application content is pushed, and if the area to which the application content is pushed is located in some particular areas (e.g., the area to which an advertisement is pushed), the application server determines to cache the application content in the content caching device corresponding to these particular areas, and distributes the application content to the content caching device corresponding to these particular areas.

Therefore, in the content processing method according to the embodiment of the present invention, the application server determines that the application content needs to be cached in the content caching device in the network, and distributes the application content to the content caching device in the network. Thus, HTTP proxy processing of a content delivery network may be avoided, thereby reducing the complexity of network processing.

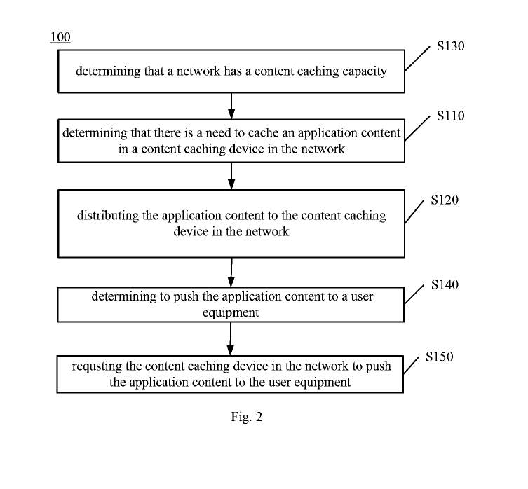

In the embodiment of the present invention, as shown in FIG. 2, besides S110 and S120, before S110 of determining that the application content needs to be cached in a content caching device in a network, the method 100 may further include:

S130, determining that the network has a content caching capacity.

In this case, in the embodiment of the present invention, in S130, the determining that the network has a content caching capacity may include:

receiving content caching capacity notification information sent by a content control network element, wherein the content caching capacity notification information is used for indicating that the network has the content caching capacity;

determining that the network has the content caching capacity according to the content caching capacity notification information.

It should be understood that, in the embodiment of the present invention, the application server may also determine whether the network has the content caching capacity according to its own configuration information. It should also be understood that, in the embodiment of the present invention, the content caching capacity that the network has may be whether the network has the content caching device, or may also be such information as a memory of the content caching device in the network, and the like.

In the embodiment of the present invention, before S120 of distributing the application content to the content caching device in the network, the method 100 may include:

sending a content caching request to a content control network element;

receiving a content caching response sent by the content control network element according to the content caching request.

Thus, in S120, the distributing the application content to the content caching device in the network may include:

distributing the application content to the content caching device in the network according to the content caching response.

In the embodiment of the present invention, the distributing the application content to the content caching device in the network according to the content caching response, may include:

distributing the application content to the content control network element according to the content caching response, so that the content control network element distributes the application content to the content caching device in the network.

Namely, after receiving the content caching request sent by the application server and determining that the network permits the application server to cache the application content in the content caching device in the network, the content control network element sends the content caching response to the application server, the application server, after receiving the content caching response sent by the content control network element, sends the application content which needs to be cached in the content control network element, and thus the content control network element may distribute the application content to the content caching device in the network.

Alternatively, in the embodiment of the present invention, the distributing the application content to the content caching device in the network according to the content caching response, may include:

distributing the application content to the content caching device in the network according to an IP address of the content caching device in the network contained in the content caching response.

Namely, in the embodiment of the present invention, after receiving the content caching request sent by the application server and determining that the network permits the application server to cache the application content in the content caching device in the network, the content control network element may also directly send the IP address of the content caching device determined to be capable of caching the application content to the application server, and the application server directly distributes the application content to the content caching device according to the IP address of the content caching device.

In the prior art, after receiving an HTTP request message sent by a UE, a CDN network does not forward the HTTP request message to an application server, but directly replies an HTTP response message to the UE and directly distributes the cached application content to the UE. Furthermore, since in the existing CDN mechanism, there is no two-way interaction between a network operator and an application content provider, the application content cached in the CDN network is processed internally, and the application content provider does not know the application content caching processing of the CDN network, the network operator could not get payment from the application content provider for the application content caching capacity of the CDN network, and thus the existing CDN mechanism could not realize the business model between a mobile operator and the application content provider.

Therefore, in the embodiment of the present invention, as shown in FIG. 2, the method 100 may further include:

S140, determining to push the application content to a user equipment;

For example, in the embodiment of the present invention, the application server may receive a content request message sent by the user equipment, wherein the content request message is used for requesting the application content, and the application server determines to push the application content to the user equipment according to the content request message.

The application server may also initiatively push the application content to the user equipment.

S150, requesting the content caching device in the network to push the application content to the user equipment.

In the embodiment of the present invention, the application server may send a first content pushing request, for requesting to push the application content to the user equipment, to the content control network element, so that the content control network element sends, according to the first content pushing request, a second content pushing request, for requesting to push the application content to the user equipment, to the content caching device which has cached the application content, and then the content caching device pushes the application content to the user equipment according to the second content pushing request.

In the embodiment of the present invention, if the application server can obtain the IP address of the content caching device which caches the application content, it is possible to directly request the content caching device which caches the application content to push the application content to the user equipment.

Namely, after sending the content caching request to the content control network element, if the received content caching response sent by the content control network element carries the IP address of the content caching device in the network, in S150, requesting the content caching device in the network to push the application content to the user equipment, may include:

sending a third content pushing request to the content caching device in the network according to the IP address of the content caching device in the network, wherein the third content pushing request is used for requesting the content caching device in the network to push the application content to the user equipment.

Therefore, in the embodiment of the present invention, according to the content processing method in the embodiment of the present invention, the application server requests the content caching device in the network to cache a content. Since the application server and the network operator may perform two-way interaction, the network operator opens its own content caching capacity to the application server and may obtain certain profits from the application server by the interaction with the application content provider, and the application server caches the content in a content caching device of a mobile network, so that the application content request of the user equipment is processed by the content caching device in the network, thereby reducing the processing load of the application server.

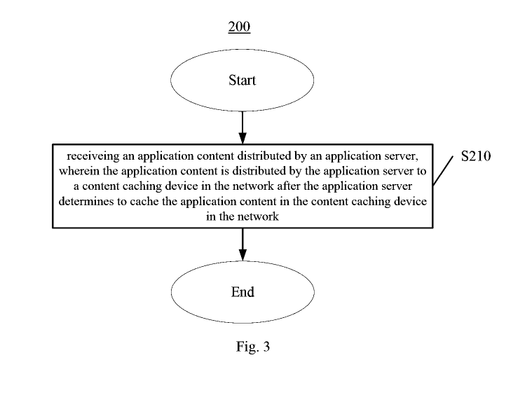

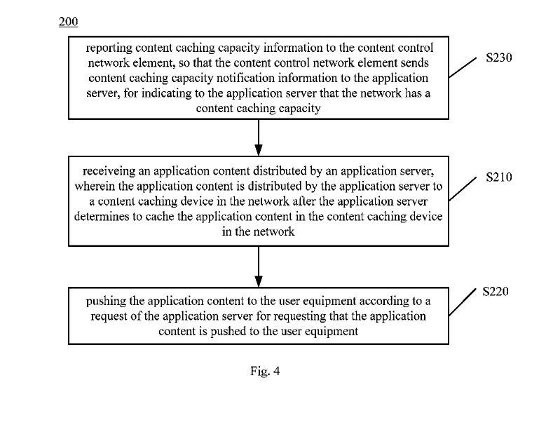

The content processing method according to the embodiment of the present invention is described above from the application server side, in combination with FIG. 1 and FIG. 2. The content processing method according to the embodiment of the present invention will be described below from the point of view of the content caching device, in combination with FIG. 3 and FIG. 4.

FIG. 3 is a schematic flow chart of a content processing method according to another embodiment of the present invention. As shown in FIG. 3, the method 200 may include:

S210, receiving an application content distributed by an application server, wherein the application content is distributed by the application server to a content caching device in the network after the application server determines to cache the application content in the content caching device in the network.

In the embodiment of the present invention, the application content received by the content caching device may be distributed by the application server through a content control network element.

In the embodiment of the present invention, as shown in FIG. 4, besides S210, the method 200 may further include:

S220, pushing the application content to the user equipment according to a request of the application server for requesting to push the application content to the user equipment.

For example, the content caching device receives a second content pushing request sent by the content control network element according to a first content pushing request for requesting to push the application content to the user equipment sent by the application server, wherein the second content pushing request is used for requesting to push the application content to the user equipment; and pushes the application content to the user equipment according to the second content pushing request.

As another example, the content caching device receives a third content pushing request sent by the application server, wherein the third content pushing request is used for requesting to push the application content to the user equipment, the third content pushing request is sent by the application server according to the IP address of the content caching device in the network carried in the content caching response, and the content caching response is sent to the application server by the content control network element after the content control network element receives the content caching request sent by the application server; and the content caching device pushes the application content to the user equipment according to the third content pushing request.

In the embodiment of the present invention, as shown in FIG. 4, the method 200 may further include:

S230, reporting content caching capacity information to the content control network element, so that the content control network element sends content caching capacity notification information to the application server, for indicating to the application server that the network has a content caching capacity.

Therefore, according to the content processing method of the embodiment of the present invention, the application server determines to cache the application content in the content caching device in the network, and distributes the application content to the content caching device in the network, thus HTTP proxy processing of a content delivery network may be avoided, thereby reducing the complexity of network processing.

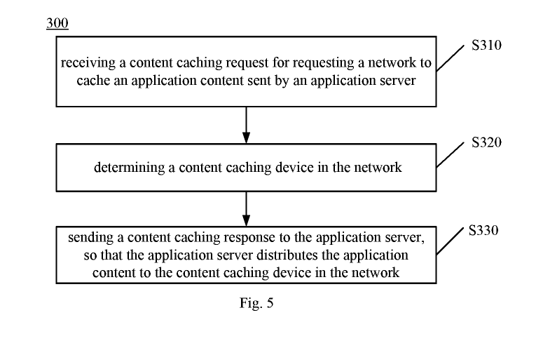

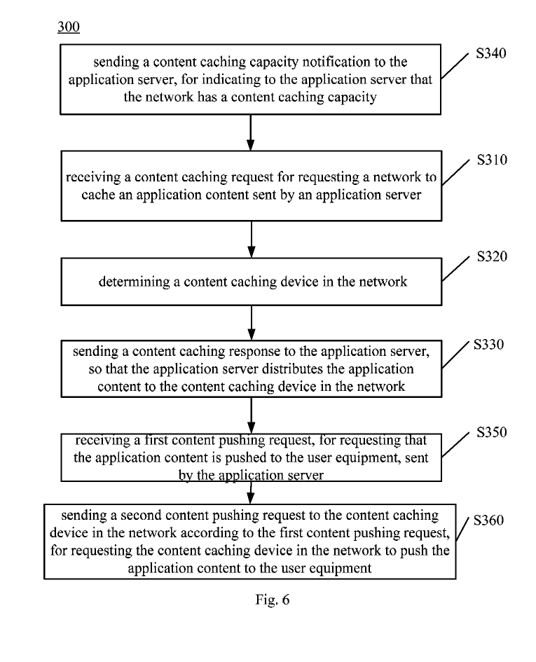

The content processing method according to an embodiment of the present invention will be described below from the point of view of the content control network element, in combination with FIG. 5 and FIG. 6.

FIG. 5 is a schematic flow chart of a content processing method 300 according to an embodiment of the present invention. The method 300 may be implemented by a content control network element. As shown in the figure, the method 300 includes:

S310, receiving a content caching request for requesting a network to cache an application content sent by an application server;

S320, determining a content caching device in the network; and

S330, sending a content caching response to the application server, so that the application server distributes the application content to the content caching device in the network.

In the embodiment of the present invention, as shown in FIG. 4, before S310 of receiving a content caching request for requesting the network to cache the application content sent by an application server, the method 300 may further include:

S340, sending a content caching capacity notification to the application server, for indicating to the application server that the network has a content caching capacity.

For example, the content control network element receives content caching capacity information sent by the content caching device in the network, and sends the content caching capacity notification to the application server according to the content caching capacity information. Alternatively, the content control network element sends the content caching capacity notification to the application server according to its own configuration information.

In the embodiment of the present invention, the content caching response may carry an IP address of the content caching device in the network, so that the application server distributes the application content to the content caching device according to the IP address.

In the embodiment of the present invention, the content control network element may also receive the application content distributed by the application server and distribute the application content to the content caching device in the network.

In the embodiment of the present invention, in S330, the sending a content caching response to the application server may include:

performing authentication and authorization processing on the application server according to the content caching request, to determine whether the network permits to cache the application content requested by the application server for caching, namely, performing authentication and authorization processing on an ASP (Application service provider, application service provider), to determine whether the ASP has permission to cache the application content in the network; if an list of ASPs (e.g., such video service providers as Tudou, Youku or the like) which permit to cache contents exists in the content control network element, the content control network element inquires whether an ASP which requests that the content is to be cached is in the list, if the ASP which requests that the content is to be cached is in the list, the content control network element determines that the network permits to perform the processing of content caching on the ASP, and if the ASP which requests that the content is to be cached is not in the list, the content control network element determines that the network does not permit to perform the processing of content caching on the ASP.

When it is determined that the network permits to cache the application content, the content caching response is sent to the application server.

In the embodiment of the present invention, in S320, the determining a content caching device in the network may include:

determining the content caching device in the network according to the content caching request which contains information about a position in which the application content is to be cached, and/or the cache capacity notification sent by the content caching device in the network.

For example, the content caching request sent by the application server to the content control network element may include information about a position in which the application content is to be cached (e.g., in an area of a certain cell), and thus the content control network element may determine the content caching device in the network according to the information about the position, and if the content control network element determines that an access network element in the network caches the application content according to the information about the position in which the application content is to be cached, then the content control network element determines the access network element in the network as the content caching device; as another example, the content control network element may determine the content caching device capable of caching the application content according to the cache capacity notification of the content caching device in the network, and if the content control network element determines that the access network element or core network element (e.g., GGSN or PDN GW) in the network has a content caching capacity according to the cache capacity notification of the content caching device, then the content control network element determines the access network element or a core network element in the network as the content caching device.

In the embodiment of the present invention, as shown in FIG. 6, the method 300 may further include:

S350, receiving a first content pushing request, for requesting to push the application content to the user equipment, sent by the application server;

S360, sending a second content pushing request to the content caching device in the network according to the first content pushing request, for requesting the content caching device in the network to push the application content to the user equipment.

For example, in the embodiment of the present invention, the content control network element may determine a content caching device which caches the application content according to the application content requested by the first content pushing request for pushing, then, determine a content caching device which needs to push the application content to the user equipment from the content caching devices which cache the application content according to the current position of the user equipment (for example, determine the content caching device closest to the current access position of the user equipment in the content caching devices which cache the application content as the content caching device which needs to push the application content to the user equipment), and send the second content pushing request to the content caching device which needs to push the application content to the user equipment, for requesting the content caching device which needs to push the application content to the user equipment to push the application content to the user equipment. If the content control network element finds out that the application content is cached in an access network element on the current position of the UE and in a gateway device of a core network, the content control network element notifies the access network element to push the content; if the application content is not cached in the access network element on the current position of the UE, but the application content is cached in the gateway device of the core network and in the CDN network element, the content control network element notifies the gateway device of the core network to push the content; if the application content is not cached in the access network element on the current position of the UE and in the gateway device of the core network, the content control network element notifies the CDN network element to push the content.

Therefore, according to the content processing method in the embodiment of the present invention, the application server determines to cache the application content in the content caching device in the network, and distributes the application content to the content caching device in the network, and thus HTTP proxy processing of a content delivery network may be avoided, thereby reducing the complexity of network processing.

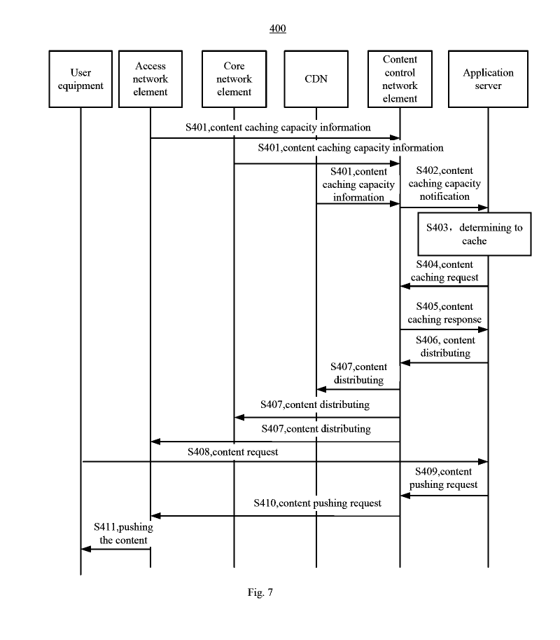

The content processing method according to the embodiment of the present invention has been described above from the point of view of the application server, the content caching device and the content control network element respectively, in combination with FIG. 1 to FIG. 6. The content processing method according to the embodiment of the present invention will be described below in a three-party interaction, in combination with FIG. 7.

FIG. 7 is a schematic flow chart of a content processing method 400 according to an embodiment of the present invention. As shown in FIG. 7, the method 400 may include:

S401, a content caching device in a network reports content caching capacity information to a content control network element, wherein the content caching device in the network may be an access network element (e.g., eNodeB, RNC and the like), or a core network element (e.g., GGSN, PDN GW and the like), or a CDN network element.

S402, after receiving the content caching capacity information sent by the content caching device, the content control network element sends a content caching capacity notification to an application server, for indicating to the application server that the network has a content caching capacity.

S403, the application server executes a content cache strategy decision, and determines to cache the application content in the content caching device in the network. A content caching strategy in the application server may be as follows:

the application server counts page views of an application content in a particular area, and if the page views of the application content exceeds a certain numerical value, then the application server determines to cache the application content in the content caching device in the network; alternatively, the application server obtains an area to which the application content is pushed, and if the area to which the application content is pushed is located in some particular areas (e.g., areas to which an advertisement is pushed), then the application server determines to cache the application content in content caching devices corresponding to these particular areas.

S404, after determining to cache the application content in the content caching device in the network, the application server sends a content caching request to the content control network element, wherein the content caching request may include the information about the position in which the application content is cached.

S405, the content control network element sends a content caching response to the application server. In this process, the content control network element may perform authentication and authorization processing on the application server, to determine whether the network permits the application server to cache the application content in the content caching device in the network (namely, performing authentication and authorization processing on an application service provider (Application service provider, referred to as “ASP” for short), to determine whether the ASP has permission to cache the application content in the network). If an list of ASPs (e.g., such video service providers as Tudou, Youku or the like) which permit to cache contents exists in the content control network element, the content control network element inquires whether an ASP which requests that the content is to be cached is in the list, and if the ASP which requests that the content is to be cached is in the list, the content control network element determines that the network permits to perform the processing of content caching on the ASP, and if the ASP which requests that the content is to be cached is not in the list, the content control network element determines that the network does not permit to perform the processing of content caching on the ASP. If the network does not permit to permit the processing of content caching on the application server, the content control network element returns content caching refuse information to the application server; and if the network permits to perform the processing of content caching on the application server, the content control network element returns the content caching response information to the application server.

S406, after receiving the content caching response information sent by the content control network element, the application server may distribute the application content to the content control network element.

S407, the content control network element distributes the application content to the content caching device in the network. In this process, the content control network element determines the content caching device which caches the application content. For example, if the access network element in the network has the content caching capacity, the application content is cached in the access network element. When determining the content caching device which caches the application content, the content caching device may also be determined according to the information about the position in which the application content is cached, for example, if the information about position in which the application content is cached is a particular cell, the content caching device may be determined as the access network element where the cell is located.

S408, the user equipment sends an application content request to the application server.

S409, after receiving the application content request sent by the user equipment, if determining the application content requested by the application content request is stored in the content caching device in the network, the application server sends an application content pushing request to the content control network element.

The application server may also actively initiate pushing of the application content to the application server, and for the pushing of the content actively initiated by the application server, if the application server determines that the application content to be pushed is stored in the content caching device in the network, the application server sends the application content pushing request to the content control network element.

S410, after receiving the content pushing request sent by the application server, the content control network element determines a content caching device caching the application content and sends a application content pushing request to the content caching device. The content control network element may also determine a content caching device caching the application content and closest to the current access position of the user equipment according to the current access position of the user equipment, for example, if an access network element which the user currently accesses has cached the application content, the content control network element selects the access network element, and sends the application content pushing request to the access network element.

S411, after receiving the content pushing request sent by the content control network element, the content caching device (e.g., access network element) pushes the application content to the user equipment.

It should be understood that, the above-mentioned method 400 is merely one embodiment of the present invention, and the embodiments of the present invention still have other implementations, rather than constituting any limit to the present invention. For example, in one implementation, in S401, the access network element, the core network element and the CDN network element do not send the content caching capacity information to the content control network element, and the content control network element sends the content caching capacity notification to the application server according to its own configuration information; or the content control network element also does not send the content caching capacity notification to the application server in S402, and the application server determines whether the network has the content caching capacity according to its own configuration information; or the application server sends the content caching request to the content control network element, if the network has no content caching device (namely, the network has no content caching capacity), then the content control network element returns content caching refuse information to the application server, if the network has the content caching device (namely, the network has the content caching capacity), then the content control network element retruns content caching response information to the application server, and the application server determines the network has the content caching capacity after receiving the content caching response information of the content control network element. For example, in another implementation, in S405, the content caching response information sent by the content control network element to the application server may carry the IP address of the content caching device, for example, the IP address of the access network element having the content caching capacity, the core network element having the content caching capacity or the CDN network element having the content caching capacity, and the application server may directly distribute the application content to the access network element, the core network element or the CDN network element without distributing the application content through the content control network element. As another example, in another embodiment, if the content caching response information sent by the content control network element to the application server carries the IP address of the content caching device, after distributing the application content to the content caching device and receiving the application content request of the user equipment, the application server may directly send the application content pushing request to the content caching device without sending the application content pushing request through the content control network element, for requesting the content caching device to push the stored application content to the user equipment.

It should also be understood that, in various embodiments of the present invention, the serial numbers of the above-mentioned processes do not mean the execution order, the execution order of the processes should be determined by the functions and internal logics thereof, and should not constitute any limit to the implementing processes of the embodiments of the present invention.

Therefore, according to the content processing method in the embodiment of the present invention, the application server determines that the application content needs to be cached needs in the content caching device in the network, and distributes the application content to the content caching device in the network, and thus HTTP proxy processing of a content delivery network may be avoided, thereby reducing the complexity of network processing.

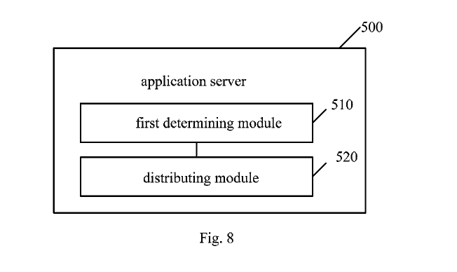

The content processing method according to the embodiments of the present invention has been described above in combination with FIG. 1 to FIG. 7. The application server, the content caching device and the content control network element according to the embodiments of the present invention will be described below, in combination with FIG. 8 to FIG. 13.

FIG. 8 is a schematic block diagram of an application server 500 according to an embodiment of the present invention. As shown in FIG. 8, the application server 500 includes:

a first determining module 510, configured to determine that there is a need to cache application content in a content caching device in a network; and

a distributing module 520, configured to distribute the application content to the content caching device in the network.

Therefore, the application server according to the embodiment of the present invention may avoid HTTP proxy processing of a content delivery network by determining that the application content needs to be cached in the content caching device in the network and distributing the application content to the content caching device in the network, thereby reducing the complexity of network processing.

Optionally, the first determining module 510 is specifically configured to:

determine that the application content needs to be cached in the content caching device in the network when page views of the application content reaches a preset threshold and/or a feature of the application content meets a preset condition.

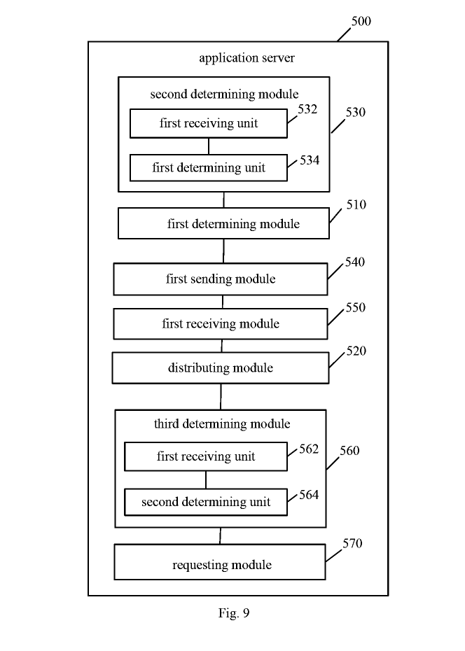

Optionally, as shown in FIG. 9, the application server 500 further includes:

a second determining module 530, configured to determine that the network has a content caching capacity.

Optionally, as shown in FIG. 9, the second determining module 530 includes:

a first receiving unit 532, configured to receive content caching capacity notification information sent by the content control network element, wherein the content caching capacity notification information is used for indicating that the network has the content caching capacity;

a first determining unit 534, configured to determine that the network has the content caching capacity according to the content caching capacity notification information.

Optionally, as shown in FIG. 9, the application server 500 further includes:

a first sending module 540, configured to send a content caching request to the content control network element;

a first receiving module 550, configured to receive a content caching response sent by the content control network element.

Optionally, the distributing module 520 is specifically configured to:

distribute the application content to the content control network element, so that the content control network element distributes the application content to a content caching device in the network.

Optionally, the distributing module 520 is specifically configured to:

distribute the application content to the content caching device in the network, according to the internet protocol IP address of the content caching device in the network contained in the content caching response.

Optionally, as shown in FIG. 9, the application server 500 further includes:

a third determining module 560, configured to determine to push the application content to a user equipment;

a requesting module 570, configured to request the content caching device in the network to push the application content to the user equipment.

Optionally, as shown in FIG. 9, the third determining module 560 includes:

a second receiving unit 562, configured to receive a content request message sent by the user equipment, wherein the content request message is used for requesting the application content; and

a second determining unit 564, configured to determine to push the application content to the user equipment according to the content request message.

Optionally, the requesting module 570 is specifically configured to:

send a first content pushing request used for requesting to push the application content to the user equipment to the content control network element, so that the content control network element sends a second content pushing request used for requesting to push the application content to the user equipment to the content caching device in the network according to the first content pushing request, and then the content caching device in the network pushes the application content to the user equipment according to the second content pushing request.

Optionally, the requesting module 570 is specifically configured to:

send a third content pushing request to the content caching device in the network according to an IP address of the content caching device in the network if the received content caching response sent by the content control network element carries the IP address of the content caching device in the network, after sending the content caching request to the content control network element, wherein the third content pushing request is used for requesting the content caching device in the network to push the application content to the user equipment.

It should be understood that, the application server 500 according to the embodiment of the present invention may correspond to the application server in the content processing method in the embodiment of the present invention, and the above-mentioned and other operations and/or functions of the modules in the application server 500 are respectively used for implementing corresponding flows of 100 to 400 of the methods in FIG. 1 to FIG. 7, and will not be repeated redundantly herein for concision.

Therefore, according to the embodiment of the present invention, the application server may avoid HTTP proxy processing of a content delivery network by determining that the application content needs to be cached in the content caching device in the network and distributing the application content to the content caching device in the network, thereby reducing the complexity of network processing. Furthermore, according to the embodiment of the present invention, a content ASP requests the content caching device of the mobile operator to cache the content, and thus two-way interaction exists between the content ASP and the mobile operator; the mobile operator opens its own content caching capacity to the third party content ASP, and may obtain some profits from the content ASP by the interaction with a content provider.

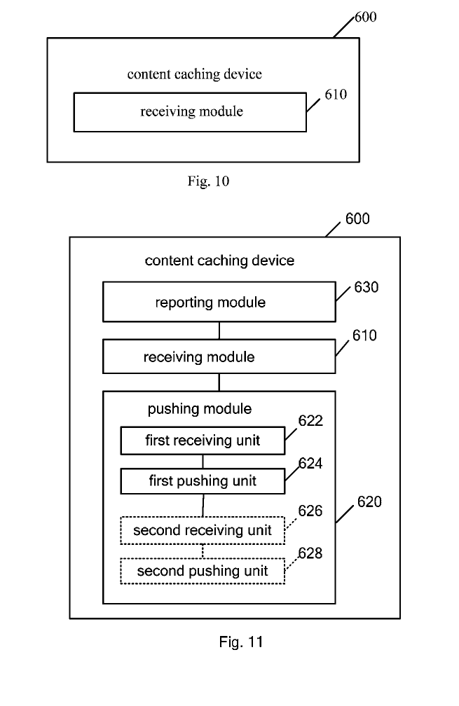

FIG. 10 is a schematic block diagram of a content caching device 600 according to an embodiment of the present invention. As shown in FIG. 10, the content caching device 600 includes:

a receiving module 610, configured to receive an application content distributed by an application server, wherein the application content is sent by the application server to a content caching device in the network after the application server determines to cache the application content in the content caching device in the network.

Therefore, according to the embodiment of the present invention, the content caching device may avoid HTTP proxy processing of a content delivery network by receiving the application content distributed by the application server after the application server determines to cache the application content to the content caching device in the network, thereby reducing the complexity of network processing.

Optionally, the receiving module 610 is specifically configured to:

receive the application content distributed by the application server through the content control network element.

Optionally, as shown in FIG. 11, the content caching device 600 further includes:

a push module 620, configured to push the application content to the user equipment according to the request of the application server for requesting to push the application content to the user equipment.

Optionally, as shown in FIG. 11, the push module 620 includes:

a first receiving unit 622, configured to receive a second content pushing request, which is sent by the content control network element according to a first content pushing request, for requesting to push the application content to the user equipment, sent by the application server, wherein the second content pushing request is used for requesting to push the application content to the user equipment; and

a first push unit 624, configured to push the application content to the user equipment according to the second content pushing request.

Optionally, as shown in FIG. 11, the push module 620 includes:

a second receiving unit 626, configured to receive a third content pushing request sent by the application server, wherein the third content pushing request is used for requesting to push the application content to the user equipment, the third content pushing request is sent by the application server according to an IP address of the content caching device in the network carried in the content caching response, and the content caching response is sent to the application server by the content control network element after the application server receives the content caching request sent by the application server; and

a second push unit 628, configured to push the application content to the user equipment according to the third content pushing request.

Optionally, the content caching device 600 further includes:

a reporting module 630, configured to report content caching capacity information to the content control network element, so that the content control network element sends content caching capacity notification information to the application server, in order to indicate to the application server that the network has a content caching capacity.

It should be understood that, the content caching device 600 according to the embodiment of the present invention may correspond to the content caching device in the content processing method in the embodiment of the present invention, the above-mentioned and other operations and/or functions of the modules in the content caching device 600 are respectively used for implementing corresponding flows of 100 to 400 of the methods in FIG. 1 to FIG. 7, and will not be repeated redundantly herein for concision.

Therefore, according to the embodiment of the present invention, the content caching device may avoid HTTP proxy processing of a content delivery network by receiving the application content distributed by the application server after determining to cache the application content in the content caching device in the network, thereby reducing the complexity of network processing.

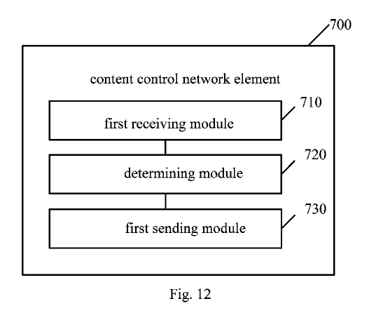

FIG. 12 is a schematic block diagram of a content control network element 700 according to an embodiment of the present invention. As shown in FIG. 12, the content control network element 700 includes:

a first receiving module 710, configured to receive a content caching request sent by an application server for requesting a network to cache an application content;

a determining module 720, configured to determine a content caching device in the network; and

a first sending module 730 configured to send a content caching response to the application server, so that the application server distributes the application content to the content caching device in the network.

Therefore, according to the embodiment of the present invention, the content control network element may avoid HTTP proxy processing of a content delivery network by determining the content caching device for the application server to cache the application content, thereby reducing the complexity of network processing.

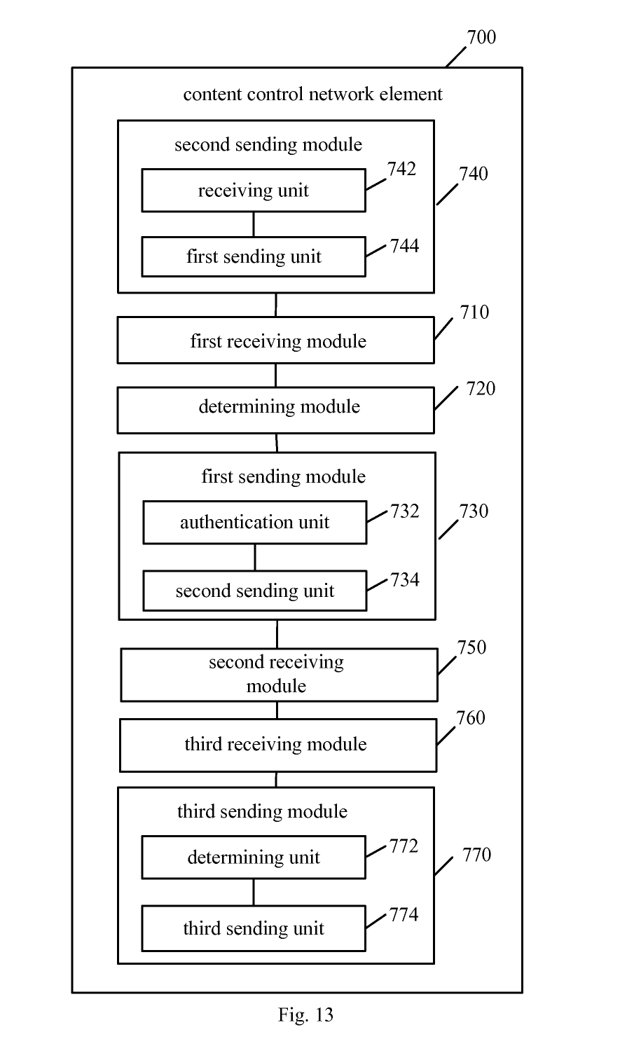

Optionally, as shown in FIG. 13, the content control network element 700 further includes:

a second sending module 740, configured to send content caching capacity notification to the application server, for indicating to the application server that the network has a content caching capacity.

Optionally, as shown in FIG. 13, the second sending module 740 includes:

a receiving unit 742, configured to receive the content caching capacity information sent by the content caching device in the network; and

a first sending unit 744, configured to send a content caching capacity notification to the application server according to the content caching capacity information.

Optionally, the determining module 720 is specifically configured to:

determine the content caching device in the network, according to the content caching request containing the information about the position in which the application content is cached, and/or the cache capacity notification sent by the content caching device in the network.

Optionally, the content caching response carries an IP address of the content caching device, so that the application server distributes the application content to the content caching device according to the IP address.

Optionally, as shown in FIG. 13, the content control network element 700 further includes:

a second receiving module 750, configured to receive the application content distributed by the application server, and distribute the application content to the content caching device in the network.

Optionally, as shown in FIG. 13, the first sending module 730 includes:

an authentication unit 732, configured to perform authentication and authorization processing on the application server according to the content caching request, to determine whether the network permits to cache the application content requested by the application server for caching; and

a second sending unit 734, configured to send the content caching response to the application server when it is determined that the network permits to cache the application content.

Optionally, as shown in FIG. 13, the content control network element 700 further includes:

a third receiving module 760, configured to receive a first content pushing request, for requesting the application content is pushed to the user equipment, sent by the application server; and

a third sending module 770, configured to send a second content pushing request to the content caching device in the network according to the first content pushing request, for requesting the content caching device in the network to push the application content to the user equipment.

Optionally, as shown in FIG. 13, the third sending module 770 includes:

a determining unit 772, configured to determine a content caching device which needs to push the application content to the user equipment from the content caching devices in the network according to the current position of the user equipment; and

a third sending unit 774, configured to send the second content pushing request to the content caching device which needs to push the application content to the user equipment, for requesting the content caching device which needs to push the application content to the user equipment to push the application content to the user equipment.

It should be understood that, the content control network element 700 according to the embodiment of the present invention may correspond to the content control network element in the content processing method in the embodiment of the present invention, and the above-mentioned and other operations and/or functions of the modules in the content control network element 700 are respectively used for implementing corresponding flows of 100 to 400 of the methods in FIG. 1 to FIG. 7, and will not be repeated redundantly herein for concision.

Therefore, according to the embodiment of the present invention, the content control network element may avoid HTTP proxy processing of a content delivery network by determining the content caching device for the application server to cache the application content, thereby reducing the complexity of network processing. Furthermore, according to the embodiment of the present invention, a content ASP requests the content caching device of the mobile operator to cache the content. Thus, two-way interaction exists between the content ASP and the mobile operator, and the mobile operator opens its own content caching capacity to the third party content ASP, and may obtain some profits from the content ASP by the interaction with a content provider.

Those of ordinary skill in the art can realize that the units and algorithmic steps of the examples described in conjunction with the embodiments disclosed herein may be realized by electronic hardware or the combination of computer software and electronic hardware. Whether these functions are executed in a hardware or software mode depends on the specific applications and design constraint conditions of the technical solution. For each specific application, professionals may realize the described functions by different methods, but this realization shall not be considered as being beyond the scope of the present invention.

Those skilled in the art to which the present invention pertains may clearly understand that, for the purpose of better convenience and briefness in description, for the specific working processes of the above-described systems, devices and units, reference could be made to the corresponding processes in the embodiments of the aforementioned methods, and repeated description is not given here.

In the several embodiments provided in the application, it shall be understood that the disclosed systems, devices and methods may be realized in other modes. For example, the embodiments of the above-described devices are only exemplary, for example, the division of the units is only a logic function division, other division modes may be adopted in practice, e.g., multiple units or components may be combined or integrated in another system, or some characteristics may be omitted or be not executed. From another point of view, the displayed or discussed mutual coupling or direct coupling or communication connection may be indirect coupling or communication connection of devices or units through some interfaces, and may also be in electrical, mechanical or other forms.

The units illustrated as separate components may be or may not be physically separated, and the components displayed as units may be or may not be physical units, that is to say, the components may be positioned at one place or may also be distributed on multiple network units. The objective of the solution of the embodiments may be fulfilled by selecting part of or all of the units according to actual needs.

In addition, in various embodiments of the present invention, the functional units may be integrated in one processing unit, or the functional units may separately and physically exist, or two or more units may be integrated in one unit.

When the functions are realized in the form of software functional units and sold or used as independent products, the functions may be stored in a computer-readable storage medium. Based on such an understanding, the technical solution of the present invention substantially, or the part of the present invention making contribution to the prior art, or a part of the technical solution may be embodied in the form of a software product, and the computer software product is stored in a storage medium, which includes a plurality of instructions enabling computer equipment (which may be a personal computer, a server, network equipment or the like) to execute all of or part of the steps in the methods of the embodiments of the present invention. The aforementioned storage medium includes: various media capable of storing program codes, such as USB disk, mobile hard disk, read-only memory (ROM, read-only memory), random access memory (RAM, random access memory), disk, optical disk or the like.

Described above are the specific embodiments of the present invention only, but the protection scope of the present invention is not limited to this, those skilled who are familiar with the art could readily think of variations or substitutions within the technical scope disclosed by the present invention, and these variations or substitutions shall fall within the protection scope of the present invention. Thus, the protection scope of the present invention should be defined by the claims.

What is claimed is:

1. A content processing method, comprising:
determining that an application content needs to be cached in a content caching device in a network; and
distributing the application content to the content caching device in the network.

2. The method of claim 1, wherein the determining that the application content needs to be cached in the content caching device in a network, comprises:
determining that the application content needs to be cached in the content caching device in the network when page views of the application content reaches a preset threshold and/or a feature of the application content meets a preset condition.

3. The method of claim 1, wherein before the distributing the application content to the content caching device in the network, the method further comprises:
sending a content caching request to the content control network element; and
receiving a content caching response sent by the content control network element.

4. The method of claim 3, wherein the distributing the application content to the content caching device in the network, comprises:
distributing the application content to the content control network element, so that the content control network element distributes the application content to the content caching device in the network.

5. The method of claim 3, wherein the distributing the application content to the content caching device in the network, comprises:
distributing the application content to the content caching device in the network according to an Internet Protocol IP address of the content caching device in the network contained in the content caching response.

6. The method of claim 1, further comprising:
determining to push the application content to a user equipment; and
requesting the content caching device in the network to push the application content to the user equipment.

7. A content processing method, comprising:
receiving an application content distributed by an application server, wherein the application content is distributed by the application server to a content caching device in a network after the application server determines to cache the application content in the content caching device in the network.

8. The method of claim 7, wherein before the receiving an application content distributed by an application server, the method further comprises:
reporting content caching capacity information to the content control network element, so that the content control network element sends the content caching capacity notification information to the application server, for indicating to the application server that the network has a content caching capacity.

9. A content processing method, comprising:
receiving a content caching request, for requesting a network to cache application content, sent by an application server;
determining a content caching device in the network; and
sending a content caching response to the application server, so that the application server distributes the application content to the content caching device in the network.

10. The method of claim 9, wherein the determining a content caching device in the network, comprises:
determining the content caching device in the network according to the content caching request which comprises information about a position in which the application content is to be cached, and/or a cache capacity notification sent by the content caching device in the network.

11. An application server, comprising:
a first determining module, configured to determine that an application content needs to be cached in a content caching device in a network; and
a distributing module, configured to distribute the application content to the content caching device in the network.

12. The application server of claim 11, wherein the first determining module is specifically configured to:
determine that the application content needs to be cached in the content caching device in the network when the page views of the application content reaches a preset threshold and/or a feature of the application content meets a preset condition.

13. The application server of claim 12, further comprising:
a first sending module, configured to send a content caching request to the content control network element; and
a first receiving module, configured to receive a content caching response sent by the content control network element.

14. The application server of claim 13, wherein the distributing module is specifically configured to:
distribute the application content to the content control network element, so that the content control network element distributes the application content to the content caching device in the network.

15. The application server of claim 13, wherein the distributing module is specifically configured to:
distribute the application content to the content caching device in the network according to an Internet Protocol IP address of the content caching device in the network contained in the content caching response.

16. The application server of claim 11, further comprising:
a third determining module, configured to determine to push the application content to a user equipment; and
a requesting module, configured to request the content caching device in the network to push the application content to the user equipment.

17. A content caching device, comprising:
a receiving module, configured to receive an application content distributed by an application server, wherein the application content is sent by the application server to a content caching device in the network after the application server determines to cache the application content in the content caching device in the network.

18. The content caching device of claim 17, further comprising:
a reporting module, configured to report content caching capacity information to the content control network element, so that the content control network element sends the content caching capacity notification information to the application server, for indicating to the application server that the network has a content caching capacity.

19. A content control network element, comprising:
a first receiving module, configured to receive a content caching request, for requesting a network to cache application content, sent by an application server;
a determining module, configured to determine a content caching device in the network; and
a first sending module, configured to send a content caching response to the application server, so that the application server distributes the application content to the content caching device in the network.

20. The content control network element of claim 19, wherein the determining module is specifically configured to:
determine the content caching device in the network, according to the content caching request which comprises information about a position in which the application content is to be cached, and/or a cache capacity notification sent by the content caching device in the network.
